(19) United States
(12) Patent Application Publication
(10) Pub. No.: US 2002/0069715 A1
(43) Pub. Date: Jun. 13, 2002

(54) Wire nut driver

(76) Inventor: Samuel A. Genco, Strongsville, OH (US)

Correspondence Address: FORREST L. COLLINS, P.O. Box 41040, BRECKSVILLE, OH, 44141-0040, US

(21) Appl. No.: 09/735,328

(22) Filed: Dec. 12, 2000

(51) Int. Cl. B25B 17/00

(52) U.S. Cl. 74/127; 81/57.42; 81/DIG. 2

(57) ABSTRACT

The present invention describes tools for fixing wire nuts to wires. The tools provide translation of linear force to rotational force thereby minimizing the turning action of a user of the tool. The tools for fixing the wire nuts may be color coded to allow quick selection of the appropriate tool for the appropriate wire nut. The tools will accommodate a variety of sizes all wire nuts and also a variety of designs of wire nuts. In one aspect of the invention, a single tool permits the user to switch from one sized wire nut to another without holstering during the tool.

### BACKGROUND OF THE INVENTION

1. Field of the Invention

The present invention relates to had tools useful for, among other purposes, fastening wire nuts.

2. Description of the Art Practices

U.S. Pat. No. 4,357,845 issued to Cornia Nov. 9, 1982 describes a universal wingnut wrench, which incorporates a grip apparatus capable of engaging various wingnut configurations, a drive apparatus adapted to be driven manually or by any of a variety of implements, and an integral magnet to adhere a wingnut to the wrench, to serve in combination as a device to facilitate the installation and removal of wingnuts from even marginally accessible locations is provided.

U.S. Pat. No. 4,982,627 issued on Jan. 8, 1991 to Johnson describes a color code tool identification method for the instant determination of the size of various types of hand tools and small cutting tools such as drill bits. A color chart is provided showing a range of ten colors. Each color indicates a particular numeral. The sequence of the indicated numerals providing a size designation for the tool. The method provides fractional inch size determination and also metric size determination. The method of Johnson may be used alone or in conjunction with conventional marking methods.

U.S. Pat. No. 4,860,618 issued to Givot Aug. 29, 1989 describes a wire nut wrench. The wrench of Givot is designed in four configurations. The first is generally cylindrical in shape and sized to fit a normal sized hand. The cylinder has a wire nut receptacle opening in the base.

A wire nut is inserted into the receptacle described in the Givot patent and the wire nut is stated to be secured to the wires. The second configuration has two receptacles, one placed on each end of the cylinder. These receptacles are sized to accommodate different styles of wire connectors. The third and fourth configurations are identical to the first and second except for the addition of a ratchet mechanism installed within the body of the cylinder. Three different types of strap arrangements are stated to be disclosed Givot to allow the tool to be hung from a tool belt when not in use.

U.S. Pat. No. 5,284,073 Wright, et al., issued on Feb. 8, 1994 is stated to describe a socket wrench opening. The Wright, et al., patent is stated to describe a wrench for turning a fastener nut having a central axis and an even-numbered plurality of flat bounding surfaces parallel to the fastener access wherein diametrically opposite pairs of surfaces are parallel to each other and the bounding surfaces intersect in adjacent pairs to form fastener corners. The wrench includes a fastener nut socket defined by a central socket axis.

The socket, according to the Wright et al., patent, includes a plurality of uniformly spaced peripherally and radially disposed sides and a plurality of uniformly spaced fastener corner clearance recesses disposed between sides. Each side includes a planar surface and a pair of complimentary surfaces, wherein a complimentary surface diverges outwardly from each end of the planar surface at an angle of approximately three degrees (3 degrees). The planar surface has a length approximately equal to 0.35 times (times) the minor diameter of the fastener nut to be driven. Each corner recess is comprised of a radiused surface, the complimentary surfaces being dimensioned to intersect the radiused surface.

Terry, in U.S. Pat. No. 5,361,657 issued on Nov. 8, 1994 describes a drive socket for imparting torque loads to a fastener element includes a body with a cavity opening to a distal end for receiving the fastener element. The cavity has protuberances projecting inwardly toward the central axis from the cavity surface to engage the fastener element. The protuberances have a frusto-pyramidal shape and are uniformly spaced circumferentially around and longitudinally along the cavity surface. The protuberances thus form a cross-hatched or knurled pattern. The cavity, described in the Terry patent, is tapered to further assist in fastener engagement. The protuberances firmly engage the fastener element at longitudinally intermittent points to apply torque loads and facilitate rotary displacement.

U.S. Pat. No. 5,263,390 Levy, et al., issued describes Nov. 23, 1993 describes a multi-fastener assembly tool for engaging at least one threaded fastener for securing the fastener to a threaded stud which includes a member having a fastener locating and holding mechanism at one end. The fastener locating and holding mechanism, according to Levy, is adapted to be squeezed through the fastener to retain it on the member. The member is seated within, and is springbased from, a circumferentially disposed socketsized to engage the fastener.

According to Levy, et al., a shaft having a handle at one end, is integrated to the socket to allow a force to be applied to urge the socket against the member once the fastener locating and holding means are aligned with the stud. As the socket is urged against the member, the threaded fastener is seated in the socket and is then pushed off the member to the stud. Once the fasteners are at the stud, a rotational motion is imparted to the handle to thread the fastener onto the stud.

Lassiter, in U.S. Pat. No. 5,974,916 issued Nov. 2, 1999 describes a wirenut driver includes a ratchet ball which drives a socket. The ratchet ball is formed with a center opening which allows the ratchet ball to receive a stem of the socket in either end thereof for rotation in either the clockwise or counterclockwise direction. The socket is formed with a center bore. The center bore is formed by a plurality of alternating channels and ribs which engage complementary shaped channels and ribs of a wirenut.

According to Lassiter, the ratchet ball produces rotation of the socket and wirenut for attaching the wirenut to a plurality of wires for electrically connecting the wires together. A pair of slots are formed in an open end of the socket adjacent the center bore for receiving a wingnut-type wirenut. The inner surface of the center bore may be stepped or tapered to receive various sizes of wirenuts.

U.S. Pat. No. 5,307,713 issued to White, May 3, 1994 describes a self-aligning wrench wherein the alignment of nut and bolt tightening wrenches relative to the nut or bolt is resolved in the instant invention by the placement of a protrusion or protrusions on one face of the wrench head. The protrusion according to White, in the preferred embodiment, extends along an axis 90 degree of the wrench handle to allow for pivoting of the wrench relative to the plane of the nut or bolt head while in use.

Kelly, et al., in U.S. Pat. No. 4,817,475 issued on Apr. 4, 1989 recites a wrench socket that has a driven end for receiving a driving wrench in an internal or female drive opening, a driving end for engaging a threaded fastener to transmit a driving torque to the fastener and an intermediate external or male drive surface area which can be engaged by a second driving wrench. Kelly, et al., states that a removable retaining member is provided to assure that the second wrench is held on the socket, and a series of sockets may be provided which have various sized driving ends, but all have identical sized female drive openings and identical sized male drive surface areas so that only a single sized first wrench or a single sized second wrench need be used to drive a range of sizes of threaded fasteners. The driving end can be in any form, such as a castellated opening, a female hex-shaped opening or a male hex-shaped projection.

To the extent that the foregoing patents and citations are relevant to the present invention they are herein incorporated by reference.

### SUMMARY OF THE INVENTION

The present invention describes a wire nut driver system for imparting rotational movement to a wire nut socket for connecting a wire nut to at least one wire comprising:

a handle segment having an elongated bore extending coaxially inwardly from one end thereof and providing a transversely extending abutment shoulder at the inner end of said bore adjacent the other end of said handle, said bore being of generally circular cross section and having an enlarged diameter portion at said one end of said handle providing an annular circumferential shoulder at said one end;

a guide member of generally circular cross section in the outer end of said bore firmly engaged with the wall of said handle defining said bore, said guide member having a bore extending coaxially therethrough from the inner end to the outer end thereof with said inner end being disposed adjacent said abutment shoulder, the wall of said guide member defining said bore therethrough having a helical thread extending along the length of said bore, said guide member having axially extending ribs about the periphery thereof terminating inwardly of the outer end thereof to provide a circumferential collar about the outer end thereof, said ribs interlocking with the material of said handle to prevent relative rotation, said guide member collar abutting said handle bore circumferential shoulder to limit movement of said guide member inwardly of said bore;

a drive spindle of generally circular cross section having a cooperating helical thread extending along the outer surface thereof, said spindle having its inner end extending through said guide member with the helical thread thereof slideably engaged with the helical thread of said guide member;

compression spring means in said bore including a compression spring having one end abutting against said abutment shoulder at the inner end of said bore in said handle and the other end biasing said spindle outwardly of said bore in said guide member;

means engaging the inner end of said spindle and limiting movement outwardly of said guide member; and, a socket segment, for when in use, receiving a wire nut;

wherein said handle segment is permanently connected to said first stem segment;

and provided further that said drive spindle segment is permanently connected to said first socket segment.

The present invention further describes a wire nut driver system for imparting rotational movement to a wire nut socket for connecting a wire nut to at least one wire comprising:

a handle segment

having a first elongated bore extending coaxially inwardly from one end thereof and providing a first transversely extending abutment shoulder at the inner end of said first bore adjacent the other end of said handle, said bore being of generally circular cross section and having an enlarged diameter portion at said one end of said handle providing a first annular circumferential shoulder at said one end;

a first guide member of generally circular cross section in the outer end of said first bore firmly engaged with the wall of said handle defining said bore, said guide member having a first bore extending coaxially therethrough from the inner end to the outer end thereof with said inner end being disposed adjacent said abutment shoulder, the wall of said guide member defining said bore therethrough having a first helical thread extending along the length of said bore, said first guide member having axially extending ribs about the periphery thereof terminating inwardly of the outer end thereof to provide a circumferential collar about the outer end thereof, said ribs interlocking with the material of said handle to prevent relative rotation, said guide member collar abutting said first handle bore circumferential shoulder to limit movement of said guide member inwardly of said bore;

a first drive spindle of generally circular cross section having a first cooperating helical thread extending along the outer surface thereof, said first spindle having its inner end extending through said guide member with the first helical thread thereof slideably engaged with the first helical thread of said guide member;

first compression spring means in said bore including a first compression spring having one end abutting against said first abutment shoulder at the inner end of said bore in said handle and the other end biasing said first spindle outwardly of said bore in said first guide member;

a first means engaging the inner end of said spindle and limiting movement outwardly of said first guide member; and, a first socket segment, for when in use, receiving a wire nut;

said handle having a second elongated bore extending coaxially inwardly from one end the opposite end thereof and providing a second transversely extending abutment shoulder at the inner end of said second bore adjacent the other end of said handle, said bore being of generally circular cross section and having an enlarged diameter portion at said one end of said handle providing a second annular circumferential shoulder at said one end;

a second guide member of generally circular cross section in the outer end of said second bore firmly engaged with the wall of said handle defining said bore, said guide member having a second bore extending coaxially therethrough from the inner end to the outer end thereof with said inner end being disposed adjacent said abutment shoulder, the wall of said guide member defining said bore therethrough having a second helical thread extending along the length of said bore, said second guide member having axially extending ribs about the periphery thereof terminating inwardly of the outer end thereof to provide a circumferential collar about the outer end thereof, said ribs interlocking with the material of said handle to prevent relative rotation, said guide member collar abutting said second handle bore circumferential shoulder to limit movement of said guide member inwardly of said bore;

a second drive spindle of generally circular cross section having a second cooperating helical thread extending along the outer surface thereof, said second spindle having its inner end extending through said guide member with the second helical thread thereof slideably engaged with the second helical thread of said guide member;

second compression spring means in said bore including a second compression spring having one end abutting against said second abutment shoulder at the inner end of said bore in said handle and the other end biasing said second spindle outwardly of said bore in said second guide member;

a second means engaging the inner end of said second spindle and limiting movement outwardly of said second guide member; and, a second socket segment, for when in use, receiving a wire nut.

The present invention also describes a wire nut driver system for connecting a wire nut to at least one wire comprising:

a first handle segment;

a first stem segment;

a first socket segment, for when in use, receiving a wire nut;

wherein said first handle segment is permanently connected to said first stem segment;

and provided further where he and said first stem segment is permanently connected to said first socket segment.

Also described as a part of the present invention is a wire nut driver system for connecting a wire nut to at least one wire comprising:

a first handle segment;

a first stem segment;

at least one second stem segment;

a first socket segment;

at least one second socket segment;

wherein said first handle segment is connected to said first stem segment;

wherein said second handle segment is connected to said second stem segment;

wherein said first stem segment is connected with said first socket segment;

and provided further that said second stem segment is connected to said second socket segment.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

With more particular reference to the drawings the following is set forth.

FIG. 1 is a side elevational view of a hand tool with a helical drive with a portion of the handle partially in section to reveal internal construction and with the spindle and chuck assembly shown in an axially displaced position in phantom line;

FIG. 2 is a fragmentary sectional view of the handle portion of the hand tool of FIG. 1 with the spring guide means and spindle shown in axially displaced position in phantom line;

FIG. 3 is a fragmentary sectional view to a scale enlarged from that in FIG. 2 showing the spindle and guide member subassembly removed from the handle bore and the spring guide member and spring in phantom line;

FIG. 4 is a sectional view along the line 4-4 of FIG. 3;

FIG. 5 is a fragmentary bottom view of the guide member spindle subassembly;

FIG. 6 is a vertical sectional view of the guide member. and

FIG. 7 is a side elevational view of an alternative hand tool with a helical drive with a portion of the handle partially in section to reveal internal construction and with the spindle and chuck assembly shown in an axially displaced position in phantom line.

### DETAILED DESCRIPTION OF THE ILLUSTRATED EMBODIMENTS

Turning now in detail to the attached drawing, therein illustrated is a hand tool embodying the present invention and comprised of a synthetic resin handle generally designated by the numeral 10, a drive spindle generally designated by the numeral 12 and the wire nut holder generally designated by numeral 14. The handle 10 is integrally formed with an elongated body portion 16 of generally circular cross section and a fluted end portion 18. A bore 20 of generally circular cross section extends coaxially inwardly of the handle 10 from the end providing the fluted end portion 18 and terminates at a point spaced inwardly from the opposite end of the handle 10 so as to provide a transversely extending shoulder 22 at its inner end.

Wedged securely in the outer end of the bore 20 is a guide member generally designated by the numeral 24 and having a generally circular cross section with axially extending shallow ribs 26 about the circumference thereof to grip firmly the synthetic resin of the handle 10 to prevent relative rotational movement. About the outer end of the guide member 24 is a circumferential collar 28 which seats on the annular shoulder 30 of the handle 10 about the outer end of the bore 20 so as to limit relative inward movement. The guide member 24 also has a bore 32 of generally circular cross section extending coaxially therethrough, and the surface defining the bore 32 thereof is provided with a pair of diametrically spaced helically extending ribs 34.

In the illustrated embodiment, the shallow ribs 26 are formed by cutting grooves in a workpiece of uniform diameter for most of the length thereof and terminating the groove cutting inwardly from the intended outer end to provide the circumferential collar 28. Slideably seated for helical movement within the guide member 24 is the spindle 12 which has a generally circular cross section and is provided with a helical groove 36 cooperatively dimensioned and configured to slideably seat therein the helical ribs 34 of the guide member 24. Thus, a force applied at the outer end of the spindle 12 will move it helically through the guide member 24 into the bore 20 of the handle 10. Adjacent the inner end of the spindle 12 is a circumferential groove 38 in which is seated a lock washer 40 to limit movement of the spindle 12 outwardly of the guide member 24.

Biasing the spindle 12 outwardly against the guide member 24 is a helical compression spring 42 disposed about the spring plug or guide generally designated by the numeral 44. The spring guide 44 has an elongated shank 46, a conical inner end 48 and a head portion 50 of enlarged diameter relative to the shank 46 so as to provide a radially extending shoulder 52 at the outer end of the shank 46. The helical spring 42 is disposed about the shank of the spring guide member 44 and acts at one end directly upon the shoulder 22 at the inner end of the bore 20 of the handle 10 and at its outer or other end against the shoulder 52 of the spring guide 44. In turn the head portion 50 of the spring guide 44 bears upon the inner end of the spindle 12 to apply the biasing pressure thereagainst.

At the outer end of the spindle 12 is the wire nut holder 14 adapted to releasably engage various types of wire nuts.

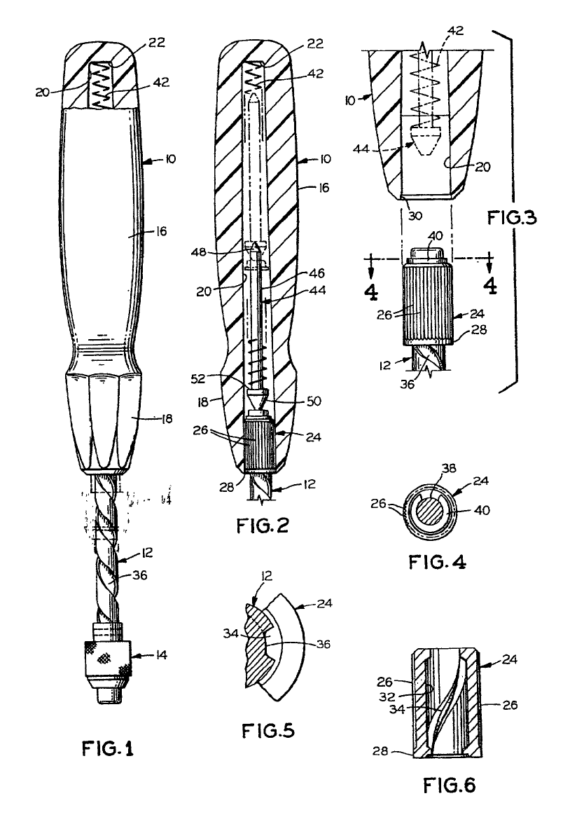

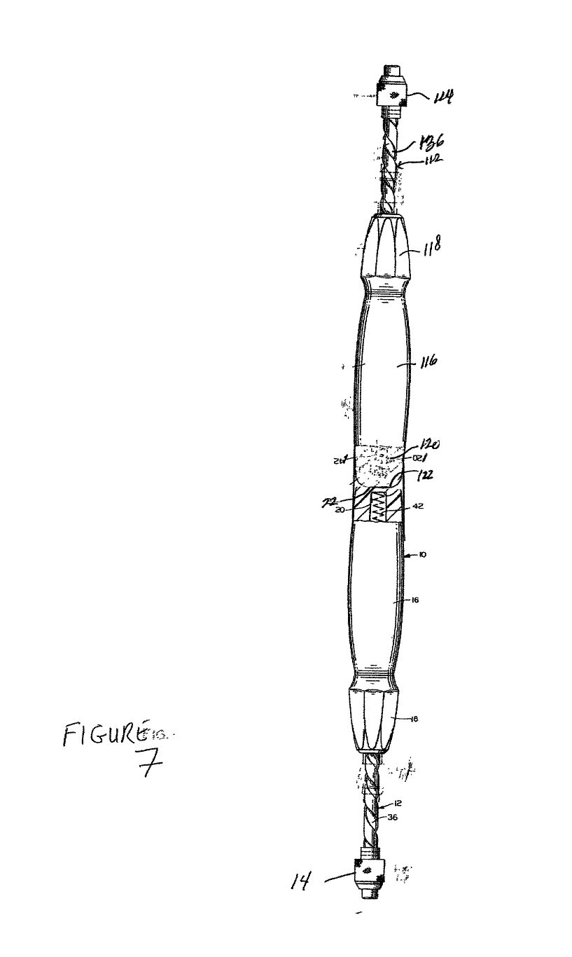

In operation of the tool of the present invention, a wire nut (not shown) is inserted into the wire nut holder 14. The tool is then moved to place the tool bit in contact with the wire (not shown) and downward pressure is applied to the handle 10. The spindle 12 moves helically within the guide member 24 as its helical groove 36 slides along the helical ribs 34, causing the spring 42 to compress. After the wire nut holder 14 has abutted against the guide member 24, the downward pressure upon the handle 10 is relieved, and the spring 42 acting upon the spring guide 44 drives the spindle 12 into the initial position shown in full line in FIG. 1.

In assembling the tool of the present invention, the spindle 12 is inserted into the guide member 24 with its helical groove 36 slideably seating the helical ribs 34 thereof The lock washer 40 is then inserted into the groove 38 adjacent the inner end of the spindle 12 and its ends are bent to maintain the members in assembly. The helical spring 42 is placed about the shank 46 of the spring guide 44 and this subassembly is inserted into the bore 20 of the handle 10. The subassembly of the spindle 12 and guide member 24 is then driven into the bore 20 and thereby locks the several elements in assembly. As the guide member 24 is driven into the bore 20, the ribs 26 embed themselves in the resin of the handle 10, and the collar 28 seats against the shoulder 30 as the resin resistance limits further movement. The wire nut holder 14 is permanently fixed upon the spindle 12.

As will be readily appreciated, the several components may vary in configuration from the components as illustrated in the accompanying drawing and in fact the spring guide member may be omitted if so desired by providing a shoulder upon the spindle against which the spring acts directly. Although the cross section of the guide member and bore may vary from the generally circular configuration illustrated, the use of generally circular configuration for the cross section of all of the several elements of the assembly facilitates obtaining optimum alignment both during manufacture and during use.

Turning now in detail to the attached drawing, therein illustrated is a second hand tool embodying the present invention. The hand tool as shown in FIG. 7 is generally similar to that shown in FIG. 1. Accordingly, the description of the lower portion of the hand tool utilizes the same numerals as in FIG. 1.

The hand tool is comprised of a second segment of a synthetic resin handle generally designated by the numeral 110, a second drive spindle generally designated by the numeral 112 and a second wire nut holder generally designated by numeral 14. The second segment of a synthetic resin handle 110 is integrally formed with an elongated second body portion 116 of generally circular cross section and a second fluted end portion 118. A second bore 120 of generally circular cross section extends coaxially inwardly of the second segment of a synthetic resin handle 110 from the end providing the a second fluted end portion 118 and terminates at a point spaced inwardly from the opposite end of the second segment of a synthetic resin handle 110 so as to provide a second transversely extending shoulder 122 at its inner end.

Wedged securely in the outer end of the second bore 120 is a second guide member generally designated by the numeral 124 and having a generally circular cross section with axially extending shallow ribs 126 about the circumference thereof to grip firmly the synthetic resin of the second segment of a synthetic resin handle 110 to prevent relative rotational movement. About the outer end of the second guide member 124 is a second circumferential collar 128 which seats on a second annular shoulder 130 of the second segment of a synthetic resin handle 110 about the outer end of the second bore 120 so as to limit relative inward movement. The second guide member 124 also has a bore 132 of generally circular cross section extending coaxially therethrough, and the surface defining the bore 132 thereof is provided with a pair of diametrically spaced helically extending ribs 134.

In the illustrated embodiment, the shallow ribs 126 are formed by cutting grooves in a workpiece of uniform diameter for most of the length thereof and terminating the groove cutting inwardly from the intended outer end to provide the circumferential collar 128. Slideably seated for helical movement within the guide member 124 is the spindle 112 which has a generally circular cross section and is provided with a helical groove 136 cooperatively dimensioned and configured to slideably seat therein the helical ribs 134 of the guide member 124. Thus, a force applied at the outer end of the spindle 112 will move it helically through the guide member 124 into the bore 120 of the handle 110. Adjacent the inner end of the spindle 112 is a circumferential groove 138 in which is seated a lock washer 140 to limit movement of the spindle 112 outwardly of the guide member 124.

Biasing the spindle 112 outwardly against the guide member 124 is a helical compression spring 142 disposed about the spring plug or guide generally designated by the numeral 144. The spring guide 144 has an elongated shank 146, a conical inner end 148 and a head portion 150 of enlarged diameter relative to the shank 146 so as to provide a radially extending shoulder 152 at the outer end of the shank 146. The helical spring 142 is disposed about the shank of the spring guide member 144 and acts at one end directly upon the shoulder 122 at the inner end of the bore 120 of the handle 110 and at its outer or other end against the shoulder 152 of the spring guide 144. In turn the head portion 150 of the spring guide 144 bears upon the inner end of the spindle 112 to apply the biasing pressure thereagainst. At the outer end of the spindle 112 is the wire nut bolder 114 adapted to releasably engage various types of wire nuts.

In operation of the tool of the present invention, a wire nut (not shown) is inserted into the wire nut holder 114. The wire nut holder 14 and the wire nut holder 114, in this embodiment may both be detachable from the spindle 12 and the spindle 112. Thus, a variety of wire nuts may be utilized with the tool two at time.

The tool is then moved to place the tool bit in contact with the wire (not shown) and downward pressure is applied to the handle 10 or the second handle 110 as previously described.

The wire nut holder 14 and the wire nut holder 114 may be coated with a rubberlike material facilitate gripping the wire nut. A portion of the tool may be coded to identify the type or size of wire nut to be affixed to the wire.

From the foregoing detailed description and the accompanying drawings, it will be appreciated that the relatively small number of parts required by the structure of the present invention facilitates manufacturing and assembly and minimizes cost. Moreover, relatively trouble-free operation is readily attained and a long lived, durable tool may be fabricated economically.

What is claimed Is:

1. A wire nut driver system for imparting rotational movement to a wire nut socket for connecting a wire nut to at least one wire comprising:
a handle segment having an elongated bore extending coaxially inwardly from one end thereof and providing a transversely extending abutment shoulder at the inner end of said bore adjacent the other end of said handle, said bore being of generally circular cross section and having an enlarged diameter portion at said one end of said handle providing an annular circumferential shoulder at said one end;
a guide member of generally circular cross section in the outer end of said bore firmly engaged with the wall of said handle defining said bore, said guide member having a bore extending coaxially therethrough from the inner end to the outer end thereof with said inner end being disposed adjacent said abutment shoulder, the wall of said guide member defining said bore therethrough having a helical thread extending along the length of said bore, said guide member having axially extending ribs about the periphery thereof terminating inwardly of the outer end thereof to provide a circumferential collar about the outer end thereof, said ribs interlocking with the material of said handle to prevent relative rotation, said guide member collar abutting said handle bore circumferential shoulder to limit movement of said guide member inwardly of said bore;
a drive spindle of generally circular cross section having a cooperating helical thread extending along the outer surface thereof, said spindle having its inner end extending through said guide member with the helical thread thereof slideably engaged with the helical thread of said guide member;
compression spring means in said bore including a compression spring having one end abutting against said abutment shoulder at the inner end of said bore in said handle and the other end biasing said spindle outwardly of said bore in said guide member;
means engaging the inner end of said spindle and limiting movement outwardly of said guide member; and,
a socket segment, for when in use, receiving a wire nut;
wherein said handle segment is permanently connected to said first stem segment;
and provided further that said drive spindle segment is permanently connected to said first socket segment.

2. The wire nut driver system according to claim 1, wherein at least one of a region of said handle segment, a region of said the stem segment, and a region of said socket segment, is distinctively marked to permit identification of said the socket segment with a particular sized wired nut.

3. The wire nut driver according to claim 2, wherein the region is distinctively marked by means of color.

4. The wire nut driver system according to claim 1, wherein the socket segment is formed from at least one metal provided further that said the socket segment has an interior portion and an exterior portion, and provided further that at least said interior portion is at least partially coated with a rubberlike material.

5. A wire nut driver system for imparting rotational movement to a wire nut socket for connecting a wire nut to at least one wire comprising:
a handle segment
having a first elongated bore extending coaxially inwardly from one end thereof and providing a first transversely extending abutment shoulder at the inner end of said first bore adjacent the other end of said handle, said bore being of generally circular cross section and having an enlarged diameter portion at said one end of said handle providing a first annular circumferential shoulder at said one end;
a first guide member of generally circular cross section in the outer end of said first bore firmly engaged with the wall of said handle defining said bore, said guide member having a first bore extending coaxially therethrough from the inner end to the outer end thereof with said inner end being disposed adjacent said abutment shoulder, the wall of said guide member defining said bore therethrough having a first helical thread extending along the length of said bore, said first guide member having axially extending ribs about the periphery thereof terminating inwardly of the outer end thereof to provide a circumferential collar about the outer end thereof, said ribs interlocking with the material of said handle to prevent relative rotation, said guide member collar abutting said first handle bore circumferential shoulder to limit movement of said guide member inwardly of said bore;
a first drive spindle of generally circular cross section having a first cooperating helical thread extending along the outer surface thereof, said first spindle having its inner end extending through said guide member with the first helical thread thereof slideably engaged with the first helical thread of said guide member;
first compression spring means in said bore including a first compression spring having one end abutting against said first abutment shoulder at the inner end of said bore in said handle and the other end biasing said first spindle outwardly of said bore in said first guide member;
a first means engaging the inner end of said spindle and limiting movement outwardly of said first guide member; and,
a first socket segment, for when in use, receiving a wire nut;
said handle having a second elongated bore extending coaxially inwardly from one end the opposite end thereof and providing a second transversely extending abutment shoulder at the inner end of said second bore adjacent the other end of said handle, said bore being of generally circular cross section and having an enlarged diameter portion at said one end of said handle providing a second annular circumferential shoulder at said one end;
a second guide member of generally circular cross section in the outer end of said second bore firmly engaged with the wall of said handle defining said bore, said guide member having a second bore extending coaxially therethrough from the inner end to the outer end thereof with said inner end being disposed adjacent said abutment shoulder, the wall of said guide member defining said bore therethrough having a second helical thread extending along the length of said bore, said second guide member having axially extending ribs about the periphery thereof terminating inwardly of the outer end thereof to provide a circumferential collar about the outer end thereof, said ribs interlocking with the material of said handle to prevent relative rotation, said guide member collar abutting said second handle bore circumferential shoulder to limit movement of said guide member inwardly of said bore;
a second drive spindle of generally circular cross section having a second cooperating helical thread extending along the outer surface thereof, said second spindle having its inner end extending through said guide member with the second helical thread thereof slideably engaged with the second helical thread of said guide member;
second compression spring means in said bore including a second compression spring having one end abutting against said second abutment shoulder at the inner end of said bore in said handle and the other end biasing said second spindle outwardly of said bore in said second guide member,
a second means engaging the inner end of said second spindle and limiting movement outwardly of said second guide member; and,
a second socket segment, for when in use, receiving a wire nut.

6. The wire nut driver system according to claim 5 wherein at least one of said first socket segment and said second socket segment is detachably connected with said first spindle or said second spindle.

7. The wire nut driver system according to claim 5 wherein at least one of said first socket segment and said second socket segment is permanently connected with said first spindle or said second spindle.

8. The wire nut driver system according to claim 5, wherein at least one of a region of said handle segment, a region of said first drive spindle, said second drive spindle, a region of said first socket segment, or said second socket segment is distinctively marked to permit identification of said first socket segment or said second socket segment with a particular sized wired nut.

9. The wire nut driver according to claim 8, wherein the region is distinctively marked by means of color.

10. The wire nut driver system according to claim 5, wherein the socket segment is formed from at least one metal provided further that said the socket segment has an interior portion and an exterior portion, and provided further that at least said interior portion is at least partially coated with a rubberlike material.

11. A wire nut driver system for connecting a wire nut to at least one wire comprising:
a first handle segment;
a first stem segment;
a first socket segment, for when in use, receiving a wire nut;
wherein said first handle segment is permanently connected to said first stem segment;
and provided further where he and said first stem segment is permanently connected to said first socket segment.

12. The wire nut driver system according to claim 11, wherein at least one of a region of said handle segment, a region of said the stem segment, and a region of said socket segment, is distinctively marked to permit identification of said the socket segment with a particular sized wired nut.

13. The wire not driver system according to claim 11, wherein the region is distinctively marked by means of color.

14. The wire nut driver system according to claim 11, wherein said handle segment has at least one portion thereof which is distinctively marked by means of color to permit identification of said socket segment with a particular sized wire nut.

15. The wire nut driver system according to claim 11, wherein the socket segment is formed from at least one metal provided further that said the socket segment has an interior portion and an exterior portion, and provided further that at least said interior portion is at least partially coated with a rubberlike material.

16. A wire nut driver system for connecting a wire nut to at least one wire comprising:
a first handle segment;
a first stem segment;
at least one second stem segment;
a first socket segment;
at least one second socket segment;
wherein said first handle segment is connected to said first stem segment;
wherein said second handle segment is connected to said second stem segment;
wherein said first stem segment is connected with said first socket segment;
and provided further that said second stem segment is connected to said second socket segment.

17. The wire nut driver system according to claim 16 wherein, at least one of said first socket segment and said second socket segment is permanently connected to said first stem segment or to said second stem segment.

18. The wire nut driver system according to claim 16 wherein, at least one of said first socket segment and said second socket segment is detachably connected to said first stem segment or said second stem segment.

19. The wire nut driver system according to claim 16 wherein, at least one of said first stem segment and said second stem segment is permanently connected to said handle segment.

20. The wire nut driver system according to claim 16 wherein, at least one of said first stem segment and said second stem segment is detachably connected to said handle segment.

21. The wire nut driver system according to claim 16, wherein at least one of a region of said handle segment, a region of said first stem segment, a region of said second stem segment, a region of said first socket segment, and a region of said second socket segment, is distinctively marked to permit identification of said first socket segment and said second socket segment with a particular sized wired nut.

22. The wire not driver according to claim 21, wherein the region is distinctively marked by means of color.

23. The wire nut driver system according to claim 16, wherein said handle segment has at least one portion thereof which is distinctively marked by means of color to permit identification of at least one of said first socket segment and said second socket segment with a particular sized wire nut.

24. The wire nut driver system according to claim 16, wherein at least one of said first socket segment and said second socket segment is formed from at least one metal; provided further that at least one of said first socket segment and said the second socket segment has an interior portion and an exterior portion, and provided further that at least one of said first interior portion and said second interior portion is at least partially coated with a rubberlike material.
